(19) United States
(12) Patent Application Publication
(10) Pub. No.: US 2026/0158838 A1
(43) Pub. Date: Jun. 11, 2026

(54) TOWING VEHICLE, COMBINATION AND METHOD FOR ESTABLISHING A MEDIA CONNECTION

(71) Applicant: Jost - Werke Deutschland GmbH, Neu-Isenburg (DE)

(72) Inventors: Alexander BASTRON, Darmstadt (DE); José Manuel ALGÜERA GALLEGO, Aschaffenburg (DE)

(21) Appl. No.: 19/414,391

(22) Filed: Dec. 10, 2025

(30) Foreign Application Priority Data
Dec. 10, 2024 (DE) 10 2024 136 865.9

(51) Int. Cl. B60D 1/64; B25J 15/00; B62D 53/08

(52) U.S. Cl. CPC B60D 1/64; B25J 15/0033; B62D 53/08

(57) ABSTRACT

A towing vehicle with a plurality of plug connectors each for transmitting a medium, which can be connected to sockets of a towed vehicle, further with a handling device.

### CROSS-REFERENCE TO RELATED APPLICATION

This application claims the benefit of German Application No. 10 2024 136 865.9, filed Dec. 10, 2024, the disclosure of which is incorporated by reference herein in its entirety.

### FIELD OF THE INVENTION

The present invention relates to a towing vehicle, a combination of several plugs and a handling device, and a method for establishing a media connection between a towing vehicle and a towed vehicle.

### BACKGROUND

Towing vehicles are used in a combination to move a towed vehicle. Examples of towed vehicles are semitrailer, trailers and swap bodies.

A tractor and a semitrailer form a tractor-trailer combination in which the mechanical coupling system comprises a fifth wheel coupling arranged on the tractor and a king pin located on the bottom side of the semitrailer, which can be engaged with and locked to the fifth wheel. The fifth wheel plate is usually designed with a wedge-shaped entry opening in the direction of travel for coupling the semitrailer, whereby the entry opening has a free installation space with at least one installation space depth that ensures the king pin can be inserted into and removed from the fifth wheel. During coupling, the semitrailer slides on the surface of the fifth wheel plate with regard to its vertical alignment. Lateral guidance is ensured by the king pin, which is positively guided in the entry opening during coupling until it reaches its locking position. A method for coupling a tractor unit and a semitrailer is known from KR 20200060650 A.

Similarly, a motor vehicle and a trailer form an articulated vehicle, in which the mechanical coupling system comprises a trailer coupling or pin coupling with a coupling jaw assigned to the motor vehicle and a drawbar with a towing eye assigned to the trailer.

Such combinations are of great importance for the transport of goods. It is common for a towing vehicle and a towed vehicle not to form a fixed combination, but for a towing vehicle to be connected to different towed vehicles of the same type as required. At the end of a journey, the towing vehicle usually parks the towed vehicle. While the towed vehicle is being loaded or unloaded, the towing vehicle can be used to move another towed vehicle. Towing vehicles and towed vehicles are therefore regularly connected and disconnected. As a result, there are generally more towed vehicles than towing vehicles. To enable semitrailer to be parked, they are usually equipped with landing gears, which take over the support function when no tractor is coupled to the semitrailer.

Combinations are used both in controlled environments, such as container terminals, and in public environments, i.e. on roads. Conditions in controlled environments are often more easily controlled. This means there are fewer disruptive influences such as road users who are not part of the goods transport system, uneven surfaces, unexpected road closures, etc. However, the reliability requirements within controlled environments are significantly higher.

Manually coupling a towing vehicle to a semitrailer is a multi-step and time-consuming process that requires several connections to be made manually. First, the towing vehicle is reversed up to the trailer until the fifth wheel coupling engages with the king pin of the trailer. An audible click signals that the mechanical connection has been established. This is followed by a visual inspection to ensure that the locking of the fifth wheel is correctly engaged.

In addition to the mechanical connection, the towing vehicle and the towed vehicle are connected to each other for the transmission of various media, in particular compressed air and electrical energy. In recent years, data connections between the towing vehicle and the towed vehicle have also become increasingly common. For the transmission of media, the vehicles often have plugs and sockets that can be attached to the corresponding media lines and connected to each other.

The manual connection process for media connections is time-consuming and prone to errors. In the case of pneumatic connections, for example, care must be taken to ensure that the connections are tight in order to avoid compressed air losses. The electrical connections between the towing vehicle and the trailer are made via separate plugs, usually 7-pin or 15-pin, for the lighting and, if necessary, via additional plug connections for control units such as ABS or EBS. These plugs must be connected individually and checked to ensure they are seated correctly. This requires a person to climb between the vehicles and handle the cables manually. Apart from the fact that the area between the vehicles is often dirty, there is also a risk of injury. If the trailer has additional systems such as hydraulics or cameras, the corresponding data cables are also connected manually.

Once all connections have been made, a functional test is carried out. This involves testing the trailer's lighting, brakes and any additional systems such as hydraulics or telematics.

However, this process has several disadvantages. It is very labour-intensive, as each connection has to be connected and checked individually, which can be particularly problematic in bad weather conditions or when time is of the essence. The large number of separate connections also increases the risk of errors, such as forgotten or incorrectly plugged conductors. This can lead to malfunctions, for example in the lighting or brakes, and thus endanger road safety.

Connecting and disconnecting the transmission cables is therefore a time-consuming task that is often carried out manually. In the past, various approaches have been taken to reduce or avoid these problems.

One approach was to combine different connections into a single plug. This reduces the number of plugging operations. The use of combined plug connections between the towing vehicle and the semitrailer offers advantages in terms of both functionality and efficiency. By combining different types of connections in a single plug, space and material can be saved and the effort required for manufacture and maintenance reduced. Especially in logistics, where fast and reliable coupling is crucial, handling is greatly simplified by combined plug systems. The risk of connecting incorrectly or forgetting a connection is significantly reduced, as only one plug is used for all necessary connections. In addition, integration into a single housing ensures better protection against external influences such as dirt, moisture and mechanical stress. Overall, combining different connections in a plug ensures greater reliability, simplified handling and, ultimately, economic advantages in operation.

In addition, attempts have been made to automate the connection of vehicles with regard to the transmission of media such as compressed air, electrical energy and data. Automation systems that also use combined plugs with multiple media connections are known from EP 2 013 040 A1, WO 2022/150720 A2 and U.S. Pat. No. 11,560,188 B2. However, these systems are susceptible to environmental influences such as rain or dirt. Furthermore, it is questionable to what extent the connection shown in FIG. 3c of U.S. Pat. No. 11,560,188 B2 is flexible enough to accommodate movements of the trailer relative to the towing vehicle on the one hand, and rigid enough to allow the plug connection to be established automatically on the other.

It can be assumed that the requirements for the transmission of media between the towing vehicle and the towed vehicle will continue to increase. With the increase in autonomous vehicle combinations and the increased use of recuperation systems and electric drives, it must be possible to transmit data and electrical energy quickly, reliably and securely at all times. Existing systems sometimes reach their limits in this regard.

### SUMMARY OF THE INVENTION

Embodiments of the invention ensure the reliable transmission of media between the towing vehicle and the towed vehicle, even when transmission performance requirements are high.

The towing vehicle comprises an undercarriage and a superstructure, as well as a plurality of plug connectors for transmitting one medium at a time between the towing vehicle and a towed vehicle, in particular for transmitting exactly one medium or several media at a time between the towing vehicle and a towed vehicle. The plug connectors are combined into several separate plugs that can be connected to sockets on the towed vehicle. The number of plugs is smaller than the number of plug connectors. The towing vehicle comprises a handling device that is configured to handle the plugs individually.

In other words, the number of plugs is at least two and the number of plug connectors is at least three. At least one plug therefore has at least two plug connectors.

Each plug connector is connected to a conductor for a medium. Plug connectors are also provided in the sockets, whereby the plug connectors of each socket are designed to be complementary to the plug connectors of at least one plug.

The inventors have recognised that it is not always possible or sensible to integrate all connection types into one plug. With each additional connection, the volume and weight of a plug increases. This increases the demands on the handling unit that handles the plug. In addition, the various transmitted media can have a negative influence on each other. This is particularly noticeable when combining a high-voltage line with a data line. The high-voltage line causes interference and data loss within the data line, which can permanently disrupt data transmission. If these media are to be transmitted in a common plug, strong shielding would be necessary, which would further increase the volume and size of the plug.

Unlike previous systems, it is therefore stipulated that at least two plugs are provided, each of which can be plugged in independently of the others, with at least one plug serving to transmit multiple media. The plug connectors for media that negatively influence each other can thus be provided in different plugs. In addition, the maximum weight that the handling device has to carry is lower. The handling device can thus be designed to be more delicate, saving space and costs.

The undercarriage comprises in particular a vehicle frame, wheels, and a drive. The superstructure comprises in particular a fifth wheel coupling. The superstructure may comprise a driver's cab. However, this may be omitted in the case of an autonomous towing vehicle.

The towing vehicle preferably comprises a control unit for controlling the handling device. Control is preferably semi-automatic or fully automatic.

A single plug connector can comprise both poles of an electrical connection.

Handling is understood in particular to mean picking up, moving, turning, placing, inserting, and/or pulling out a plug.

As mentioned above, the handling device is configured to handle the plugs individually. For this purpose, the handling device and the plugs preferably comprise complementary holding means. More precisely, the handling device and the plugs each comprise a holding means, wherein the holding means of the plugs are each individually complementary to the holding means of the handling device. By means of the holding means, the handling device can be temporarily connected to a single plug at a time. Complementary means that a holding means of the handling device and a holding means of a plug can be temporarily connected to each other in such a way that the handling device can handle the plug. The holding means are detachable from each other, i.e. they can be separated from each other during normal use and, in particular, without human intervention.

The holding means can be formed by a contour or partial contours of the plug, in particular the plug housing. This simplifies the construction of the plugs. If the plugs all have the same contour or partial contour, they can be handled by one and the same complementary handling device.

The plugs preferably have identical retaining means. In this case, it is sufficient for the handling device to comprise a single retaining means which is complementary to the identically designed retaining means of the plug. This simplifies the design of the handling device.

The holding means can be, for example, mechanical and/or magnetic holding means. The decisive factor is that the holding means enable a temporary connection, i.e. the connection and release of the handling device and the plug. Mechanical holding means effect a temporary connection between the handling device and the plug by means of a form fit and/or a force fit. The retaining means may also comprise latching elements and/or actuators. Magnetic retaining means may comprise a permanent magnet and/or an electromagnet. The retaining means include, for example, holders and grippers, whereby the gripper can grip the holder. The gripper may also be designed as a vacuum gripper or magnetic gripper.

The plugs preferably comprise coding, in particular unique coding. The coding is preferably different for the various plugs (unique coding). This makes it easy to determine which plug is involved and which plug connections it comprises. A sensor may be provided for this purpose, in particular as a component of the handling device. The sensor can detect the coding. A control unit can then determine, for example, on the basis of a database, which plug connections the plug with the detected coding comprises. The control unit is preferably part of the towing vehicle. The coding is preferably part of the holding means. However, it can also be arranged on or in a housing of the plug, for example. The coding can comprise, for example, an RFID chip, a QR code, a mechanical coding and/or a magnetic coding. A mechanical coding can be realised, for example, by means of differently shaped projections. The different projections can be detected optically or mechanically by the sensor. If the plugs each have an identical partial contour as a retaining means, another part of the contour of the plug, in particular the plug connector housing, can serve as coding.

The media transmitted by the plug connectors are, in particular, compressed air, hydraulic fluid, data and/or electrical energy, in particular energy from an on-board power supply (12 V DC and/or 24 V DC and/or 48 V DC) and/or high-voltage energy (>230 V AC or >230 V DC, in particular 300 V or 500 V DC). Data transmission is not understood to be the transmission of electrical energy, even if small amounts of electrical energy are transmitted in the process. As already mentioned, the transmission of high-voltage energy and data transmission is preferably carried out by two different plugs.

The plug connectors are each configured either to transmit exactly one medium between the towing vehicle and the towed vehicle or to transmit several media between the towing vehicle and the towed vehicle. In the latter case, data transmission in combination with compressed air or electrical energy is provided for in particular. For this purpose, the data is superimposed during the transmission of compressed air or electrical energy. The transmission of exactly one medium per plug connector creates a clear separation of the media. The transmission of several media via one plug connector reduces the number of plug connectors and thus reduces the size of the associated plug. This allows the handling device to be designed in a more delicate manner.

The plug connectors of a plug are advantageously insulated from each other.

Which plugs are equipped with which plug connectors can be implemented in different ways depending on the application. Preferably, at least one plug has only plug connectors for transmitting high voltage. Advantageously, the plugs are designed differently with regard to their plug connectors and/or the transmitted medium. For example, to prevent a high-voltage line and a data line from influencing each other, a first plug can be connected to the high-voltage line and equipped with a corresponding plug connector, and a second plug can be connected to a data line and have a corresponding plug connector. If compressed air transmission is also to be enabled, the first plug or the second plug may additionally have a plug connector for compressed air and be connected to a compressed air line. Since high-voltage lines are comparatively heavy, it is advantageous to provide that at least one plug has only a plug connector for transmitting high voltage and is connected to the high-voltage line. In order not to lose all the advantages of integrating several plug connectors into fewer plugs, it is advantageous to provide at least one plug designed to transmit several different media.

A plug connector is understood to be, in particular, an element that can be connected to another plug connector by means of a plugging operation, in particular by mechanical and/or magnetic connection. It is not absolutely necessary for there to be direct contact between the components that are directly involved in the transmission of the respective medium. For example, a transmitter and a receiver of a contactless communication system may be arranged in the plug connectors for a data connection, for example as disclosed in WO 2020/016420 A2. In this case, too, there are two plug connectors.

Within the scope of the invention, it is possible to provide several plugs which transmit at least some of the same media in different combinations. In this way, the system according to the invention can be adapted to or prepared for different towed vehicles. For example, it would be possible to provide three different plugs, of which a first plug is designed for the transmission of high voltage, a second plug for the transmission of compressed air and low voltage (on-board power supply) and a third plug for the transmission of compressed air, low voltage, and data. Depending on the type of towed vehicle to be connected to the towing vehicle, only the second plug (trailer without high voltage and data connection) or only the third plug (trailer without high voltage but with data connection) or the first and third plugs (trailer with high voltage and data connection) or another combination is then used.

The handling device preferably operates automatically, in particular autonomously. It preferably comprises an articulated arm robot. This greatly simplifies handling, in particular the holding of different plugs. The holding means of the handling device is preferably arranged at one end of the handling device, in particular at the end of the articulated arm robot. This gives the handling device the greatest possible scope for handling the plugs.

The towing vehicle advantageously comprises a support on which the plugs can be temporarily placed. The plugs can be placed there when they are not in use, i.e. in particular when they are not connected to the towed vehicle or are being handled by the handling device. They are thus stored in a fixed location and are easy for the handling device to find. The supports can be arranged on the driver's cab.

The task of the invention is also solved by a combination comprising a towing vehicle as described above and a towed vehicle. The towed vehicle comprises sockets to which the plugs can be connected. The sockets comprise plug connectors that are connected to media lines of the towed vehicle.

The transfer of a medium from the towing vehicle to the towed vehicle takes place from a media line of the towing vehicle via the corresponding plug connector of the towing vehicle, then via the corresponding plug connector of the towed vehicle to the media line of the towed vehicle. The transfer of a medium from the towed vehicle to the towing vehicle takes place from a media line of the towed vehicle via the corresponding plug connector of the towed vehicle, then via the corresponding plug connector of the towing vehicle to the media line of the towing vehicle. This allows, for example, electrical energy to be transferred to an energy storage device in the towing vehicle during energy recuperation by electric axles of the towed vehicle. Transmission in both directions is also possible, for example in the case of signal transmission.

The towed vehicle is preferably a semitrailer, a trailer, or a swap body.

Certain embodiments of the invention can include a combination of several plugs and a handling device as defined above. The combination can be arranged on a towing vehicle and/or on a towed vehicle. Arrangement on the towing vehicle is preferred, as a vehicle fleet usually comprises fewer towing vehicles than towed vehicles and therefore the cost is lower.

Certain embodiments of the invention include a method for establishing a media connection between a towing vehicle as described above and a towed vehicle, wherein the plugs are connected one after the other by the handling device to sockets on the towed vehicle. Since the plugs are handled individually by the handling device, they are connected to the towed vehicle one after the other.

The connection process for a plug begins with the plug being picked up by the handling device, whereby the holding means of the handling device and the plug are temporarily connected to each other. The connection process ends when the plug is connected to the socket of the towed vehicle and the handling device is detached from the plug, whereby the retaining means are separated from each other.

The handling device is also configured to perform the reverse process. Disconnecting a connection between the towing vehicle and the towed vehicle begins with the temporary connection of the retaining means of the plug and the handling device. The plug is then pulled out of the socket and placed in a designated location, for example on the support. When the plug is placed on the support, the plug and the handling device or their retaining means are separated from each other, thereby completing the process.

The connection and disconnection processes for media transmission can take place before, during or after the respective mechanical process.

In order to meet the requirements for autonomous driving combinations, data exchange between the towing vehicle and the towed vehicle is of great importance. In advantageous further developments, it is therefore envisaged that the first plug to be connected to the towed vehicle will be a plug that enables data transmission between the towing vehicle and the towed vehicle. This can be a pure data plug or a combined plug with, among other things, a data connector. In this way, data exchange between the towing vehicle and the towed vehicle can take place at an early point in time. This allows, for example, an autonomously driving towing vehicle to receive information from the towed vehicle, in particular about its superstructure and condition. Advantageously, after enabling data transmission, the plugs to be connected to the towed vehicle and the order in which they are to be connected are determined depending on the data transmitted from the towed vehicle to the towing vehicle. Once the data connection has been established, the towing vehicle can then determine which further connections are necessary and whether there is a preferred order for connecting them. This procedure facilitates the connection process between the towing vehicle and the towed vehicle, as not all information needs to be available in advance.

Once data transmission has been enabled, it is advantageous to deactivate individual or all electrical energy consumers by means of data transmission, and only then connect a plug to the towed vehicle that enables the transmission of electrical energy between the towing vehicle and the towed vehicle, in particular with regard to the consumers. When connecting electrical plug connectors, voltage spikes or even voltage arcs and sparking can occur if consumers are already active. Voltage spikes can damage electrical systems and should be avoided. If several consumers are active, multiple voltage spikes can even add up. With regard to electric arcs and sparking, it is even more important that these are avoided, as they can cause damage to the vehicles or the load and pose a considerable hazard, especially when transporting dangerous goods. If the consumers are deactivated before connection, voltage spikes, electric arcs and sparking can be avoided. This procedure is particularly advantageous when connecting the high-voltage cable.

The system according to the invention also enables, in some cases, not to establish all of the connections actually intended for this combination of towing vehicle and towed vehicle between the towing vehicle and a specific towed vehicle. For example, only some of the possible connections may be established for a shunting manoeuvre. This shortens the connection process, which saves time. During a shunting manoeuvre, for example, high-voltage transmission can be dispensed with, as it is not absolutely necessary to transmit electrical energy from recuperation. In other cases, the data line may be dispensed with, as no data exchange between the towing vehicle and the towed vehicle is necessary for the shunting manoeuvre.

The invention is illustrated and explained by way of example with reference to the drawings.

### BRIEF DESCRIPTION OF THE DRAWINGS

The figures listed below are shown in the drawings:

FIG. 1 is a schematic representation of a combination

FIG. 2 is detail A of FIG. 1

FIG. 3 is detail B of FIG. 1

FIG. 4 is detail C of FIG. 1.

### DETAILED DESCRIPTION

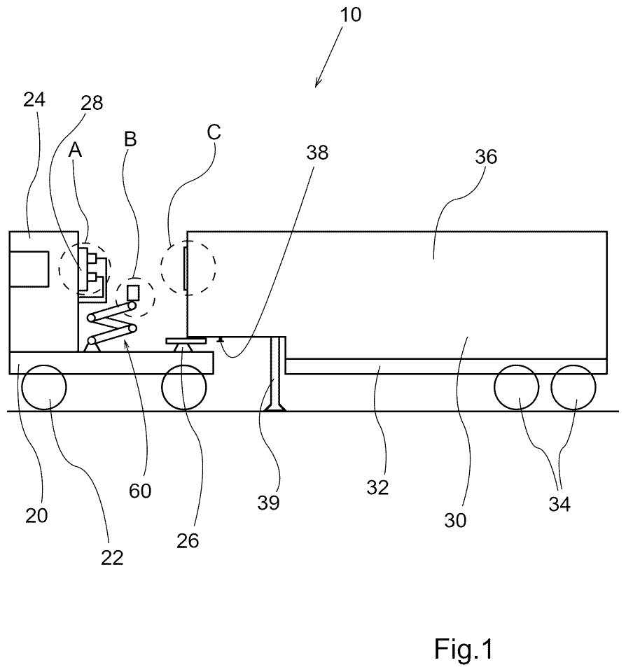

The combination 10 shown in FIG. 1 comprises a tractor as the towing vehicle 20 and a semitrailer as the towed vehicle 30. FIG. 1 shows the combination 10 during the mechanical coupling procedure of the towing vehicle 20 and the semitrailer.

The towing vehicle 20 comprises an undercarriage and a superstructure. The undercarriage comprises wheels 22 and a drive system (not shown). A driver's cab 24 is provided in the front section of the towing vehicle 20, and a fifth wheel 26 is provided in the rear section.

The towed vehicle 30 comprises a chassis 32 on which wheels 34 are arranged. A box 36 for holding transported goods is arranged on the chassis 32. The semitrailer has a king pin 38 in the front area. In order to support the semitrailer when it is not connected to a towing vehicle 20, the semitrailer comprises extendable and retractable landing gear 39.

In the state shown in FIG. 1, the towing vehicle 20 has already partially driven under the semitrailer and is moved further backwards during the course of the mechanical coupling procedure until the king pin 38 is received in the fifth wheel 26. The landing gear 39 are extended because the towing vehicle 20 does not yet fully support the semitrailer.

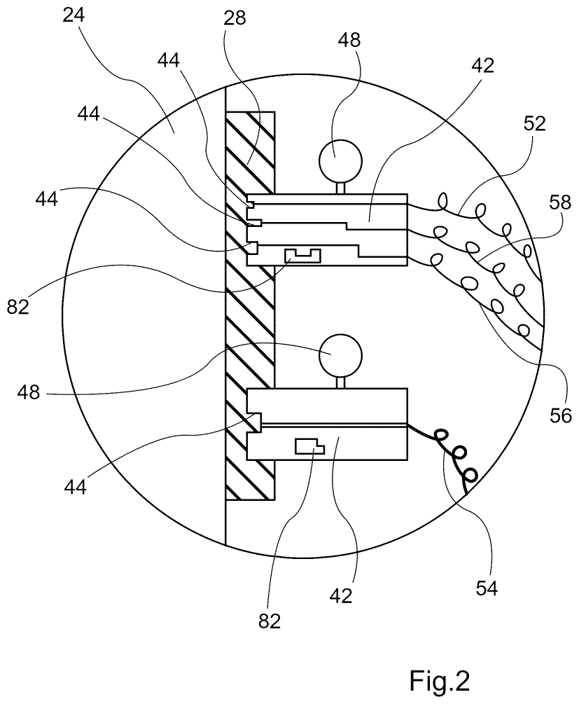

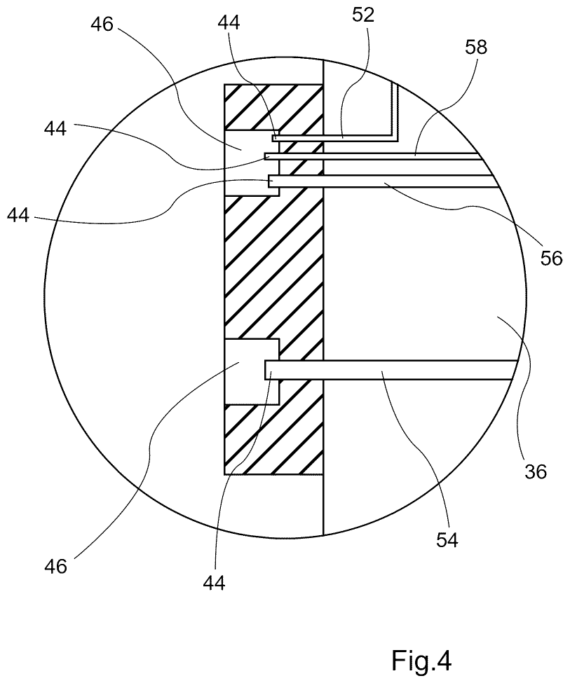

A retaining panel 28 is provided at the rear of the driver's cab 24. The towing vehicle 20 comprises several plugs 42 (see FIG. 2) which can be connected to sockets 46 on the trailer (see FIG. 4).

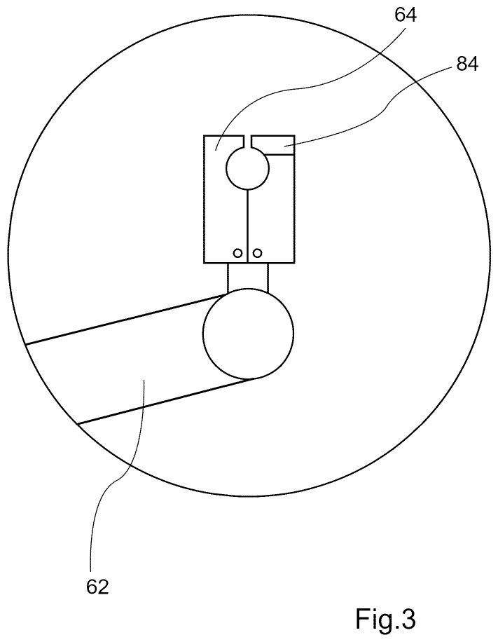

The towing vehicle 20 also comprises a handling device 60 in the form of an articulated arm robot. In the embodiment shown here, the handling device 60 is arranged between the driver's cab 24 and the fifth wheel 26. The handling device 60 comprises a robot arm 62 and a gripper 64, which is arranged at the front end of the robot arm 62 (see FIG. 3).

The plugs 42 each have a base body to which an identical holder 48 is attached. The holders 48 and the gripper 64 are designed to be complementary to each other. The gripper 64 can grip a maximum of one of the holders 48 at any given point in time and thus handle a maximum of one of the plugs 42.

Three conductors are connected to one plug 42: a data conductor 52, a pneumatic conductor 56 and a low-voltage conductor 58. This plug 42 has four plug connectors 44, each of which is connected to one of the conductors and enables transmission of the respective medium. Only one high-voltage conductor 54 and an associated plug connector 44 are provided on the other plug 42. The conductors are designed as spiral conductors.

Each of the plugs 42 has an RFID chip 82 as coding. The RFID chips 82 allow the plugs 42 to be distinguished from one another.

The holding panel 28 is only one option for temporarily storing the plugs 42. The holding panel 28 does not have any connections for media transmission.

The gripper 64 comprises two halves (see FIG. 3). The two halves can be pivoted and can thus grip the holders 48. When the gripper 64 grips a holder 48, the gripper 64 and holder 48 are temporarily connected to each other as holding means, in this case by a form fit. The handling device 60 can then handle the associated plug 42, i.e. remove it from the holding panel 28 and move it to the semitrailer.

Two sockets 46 are provided on the semitrailer (see FIG. 4). One of the sockets 46 has three plug connectors 44 which are connected to three conductors, a data conductor 52, a pneumatic conductor 56 and a low-voltage conductor 58. When the appropriate plug 42 is inserted into the socket 46, the data cables 52, the pneumatic cable 56 and the low-voltage cable 58 of the towing vehicle 20 and the semitrailer are connected to each other. This enables the transmission of data, compressed air and electrical energy via low voltage. The second socket 46 of the semitrailer has a plug connector 44 that is connected to a high-voltage cable 54. When the matching plug 42 is inserted into the socket 46, the high-voltage lines 54 of the towing vehicle 20 and the semitrailer are connected to each other. This enables the transmission of electrical energy by means of high voltage.

The sockets 46 do not necessarily have to be recesses. In other embodiments, the plugs may also have a recess into which a projection protrudes as a socket 46. In any case, the only decisive factor is that the plug 42 and the socket 46 can be temporarily connected to each other by means of a plugging operation.

The plugs 42 are moved by the handling device 60 to the sockets 46 and inserted into them. The gripper 64 can then open, disconnecting the temporary connection between the gripper 64 and the holder 48 of the respective plug 42. The gripper 64 can then pick up another plug.

The gripper 64 comprises a sensor 84. The sensor 84 can detect the coding, in this case the RFID chips 82. A control unit (not shown) can then, for example, use a database to determine which plug connections the plug with the detected coding comprises.

### LIST OF REFERENCE SYMBOLS

10 Combination
20 Towing vehicle
22 Wheel
24 Driver's cab
26 Fifth wheel
28 Retaining panel
30 Towed vehicle
32 Chassis
34 Wheel
36 Box
38 King pin
39 Landing gear
42 Plug
44 Plug connector
46 Socket
48 Holder
52 Data cable
54 High-voltage cable
56 Pneumatic cable
58 Low-voltage cable
60 Handling device/articulated arm robot
62 Robot arm
64 Gripper
82 RFID chip
84 Sensor

1. A towing vehicle comprising an undercarriage and a superstructure and a plurality of plug connectors for transmitting respective media between the towing vehicle and a towed vehicle, characterised
in that the plug connectors are combined to form a plurality of separate plugs that can be connected to sockets of the towed vehicle, the number of plugs being smaller than the number of plug connectors, and
in that the towing vehicle comprises a handling device that is configured to handle the plugs individually.

2. The towing vehicle according to claim 1, characterised in that the handling device and the connectors comprise complementary holding means by means of which the handling device can be temporarily connected to a single connector in each case, the holding means optionally being mechanical and/or magnetic holding means.

3. The towing vehicle according to claim 2, characterised in that the plugs have identical retaining means, in particular in the form of a contour or partial contour.

4. The towing vehicle according to claim 2, characterised in that the plugs, in particular the retaining means, comprise a coding, in particular an RFID chip, a QR code, a mechanical coding, and/or a magnetic coding.

5. The towing vehicle according to claim 1, wherein the media comprise compressed air, hydraulic fluid, data, or electrical energy, and optionally energy from an on-board power supply (12 V DC and/or 24 V DC) and/or energy with high voltage (>230 V AC/DC).

6. The towing vehicle according to claim 1, wherein at least one plug is designed to transmit several different media, with at least one plug optionally having plug connectors exclusively for transmitting high voltage.

7. The towing vehicle according to claim 1, wherein the plugs are designed differently with regard to the transmitted respective media or with regard to their plug connectors.

8. The towing vehicle according to claim 5, wherein the transmission of the energy with high voltage and the data transmission are carried out by two different plugs.

9. The towing vehicle according to claim 1, wherein the handling device comprises an articulated arm robot with a gripper.

10. An article of manufacture comprising a plurality of plugs and a handling device configured to handle each plug individually, each plug comprising a plug connector, and at least one plug of the plurality of plugs comprising a plurality of plug connectors, each plug connector configured to transmit a respective medium between a towing vehicle and a towed vehicle and configured to connect to a respective socket of the towed vehicle.

11. A method for establishing a media connection between a towing vehicle and a towed vehicle, the method comprising obtaining a towing vehicle according to claim 1; and connecting each of the plurality of plugs to the towed vehicle; wherein the plugs are successively connected by the handling device to sockets of the towed vehicle.

12. The method according to claim 11, wherein connecting a first plug to the towed vehicle enables data transmission between the towing vehicle and the towed vehicle.

13. The method according to claim 12, characterised in that, after enabling the data transmission, determining, depending on data transmitted from the towed vehicle to the towing vehicle, which connectors are subsequently connected to the towed vehicle and in which order.

14. The method according to claim 12, characterised in that after enabling the data transmission, individual or all consumers of electrical energy are deactivated by means of the data transmission and then a plug is connected to the towed vehicle, which enables the transmission of electrical energy between the towing vehicle and the towed vehicle.

15. The method according to claim 11, characterised in that only some of the possible connections are established for a shunting movement.
